(19) United States
(12) Patent Application Publication
(10) Pub. No.: US 2007/0263775 A1
(43) Pub. Date: Nov. 15, 2007

(54) Distributed system and method for diagnosing network problems

(76) Inventor: Alan D. Clark, Duluth, GA (US)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 11/615,188

(22) Filed: Dec. 22, 2006

Related U.S. Application Data
(60) Provisional application No. 60/753,288, filed on Dec. 22, 2005.

(51) Int. Cl. H04M 1/24; H04M 3/08; H04M 3/22

(52) U.S. Cl. 379/1.01

(57) ABSTRACT

The present invention provides a distributed system and method for diagnosing problems in a signal at an endpoint in a network. The distributed system comprises a quality of service monitor located at the endpoint and a system manager located generally remote from the endpoint. The quality of service monitor includes a call quality analysis component, a parameter capture component, and a problem reporting component. The call quality analysis component monitors values of call quality parameters in order to detect a quality problem in the signal. Upon detection of the quality problem, the parameter capture component samples values of call quality parameters at a shortened sampling interval. The parameter reporting component incorporates the values sampled by the parameter capture component into a problem call quality report for transmission over the network. The system manager receives and stores the problem call quality report for subsequent review.

### RELATED APPLICATION

This application claims the benefit of priority of U.S. provisional application Ser. No. 60/753,288, filed Dec. 22, 2005, which is relied on and incorporated herein by reference.

### FIELD OF THE INVENTION

The present invention relates to network monitoring systems and methods. More particularly, the present invention relates to a distributed system and method for diagnosing problems in a signal at an endpoint in a network system, wherein the capabilities of a conventional network probe or analyzer may be replicated as virtual functions.

### BACKGROUND OF THE INVENTION

The use of network test equipment such as probes and analyzers for diagnosing network problems is well established. To facilitate the identification of network problems, such devices are attached to a packet network to capture and analyze packets passing the monitored point and to report or display data derived from the analysis of the packet contents. Because placing test equipment at remote endpoints is expensive and impractical, it is common to attach such probes and analyzers to networks at points where there is a large amount of aggregated traffic.

For example, a residential voice over IP service comprises a large number of simple endpoint devices such as residential gateways, analog telephone adaptors, IP phones or soft phones (collectively referred to as customer premise equipment). Such customer premise equipment is attached to an IP network via a broadband network connection. This allows voice over IP packets to be transferred between the customer premise equipment for one subscriber and the customer premise equipment for another subscriber. Congestion on broadband network connections such as DSL or cable modems is common, and results in intermittent quality problems on voice over IP calls. The manager of the residential voice over IP service therefore needs to be able to identify and resolve these problems. However, it is generally cost prohibitive to place conventional network probes or analyzers at the customer premise.

A further problem results from the potentially large number of subscribers, which may reach into the tens of millions. For example, if subscriber A reports that he or she has been experiencing problems, then a network manager may be assigned to investigate. Because IP problems are transient in nature, the network manager cannot reliably expect that problems will occur at the time he or she checks the subscriber's connection. Moreover, it is generally impractical for the network manager to monitor the connections of all the subscribers that have reported problems in the hope of catching a transient problem.

A need therefore exists for an improved network monitoring system and method that overcomes these problems.

### SUMMARY OF THE INVENTION

The present invention answers this need by providing a system and method wherein a large scale residential voice over IP or IPTV service, IP cellular service, or large enterprise voice over IP deployment can be effectively monitored, thereby allowing a network manager to capture information relating to transient problems using functionality previously limited to large network probes and analyzers.

In accordance with the present invention, a distributed system for diagnosing problems in a signal at an endpoint in a network comprises a quality of service monitor located at the endpoint and a system manager located generally remote from the endpoint. The quality of service monitor includes a call quality analysis component, a parameter capture component, and a problem reporting component. The call quality analysis component monitors values of call quality parameters in order to detect a quality problem in the signal. Upon detection of the quality problem, the parameter capture component samples values of call quality parameters at a shortened sampling interval. The parameter reporting component incorporates the values sampled by the parameter capture component into a problem call quality report for transmission over the network. The system manager receives and stores the problem call quality report for subsequent review.

In one embodiment, a standard reporting component is provided to sample values of call quality parameters at a normal sampling interval, incorporate the sampled values into a standard call quality report, and transmit the standard call quality report over the network to the system manager. Thus, a normal sampling interval is used while monitoring for a quality problem associated with the call signal and, if a quality problem is detected, a shortened sampling interval is used in order to gather sufficient data to diagnose the quality problem.

In another embodiment, the call quality analysis component detects a quality problem by comparing the monitored values of the quality parameters to a threshold. If the monitored values of one or more of the quality parameters exceed the threshold, a quality problem is detected and the parameter capture component is signaled to begin sampling at the shortened sample intervals.

In further embodiments, the problem reporting component incorporates the values sampled by the parameter capture component into the problem call quality report by performing quantizing and compression operations on the sampled data.

It is thus an object of the present invention to provide a system and method wherein very large numbers of endpoints may be monitored when problems occur to obtain useful, detailed data for troubleshooting such problems.

Further objects, features and advantages will become apparent upon consideration of the following detailed description of the invention when taken in conjunction with the drawings and the appended claims.

### BRIEF DESCRIPTION OF THE DRAWINGS

FIG. 1 is a relational diagram showing a distributed system for diagnosing network problems in an embodiment of the present invention.

FIG. 2 is a schematic diagram of an analog telephone adaptor used in an embodiment of the present invention.

FIG. 3 is a schematic diagram of a quality of service monitor in an embodiment of the present invention.

### DETAILED DESCRIPTION OF THE INVENTION

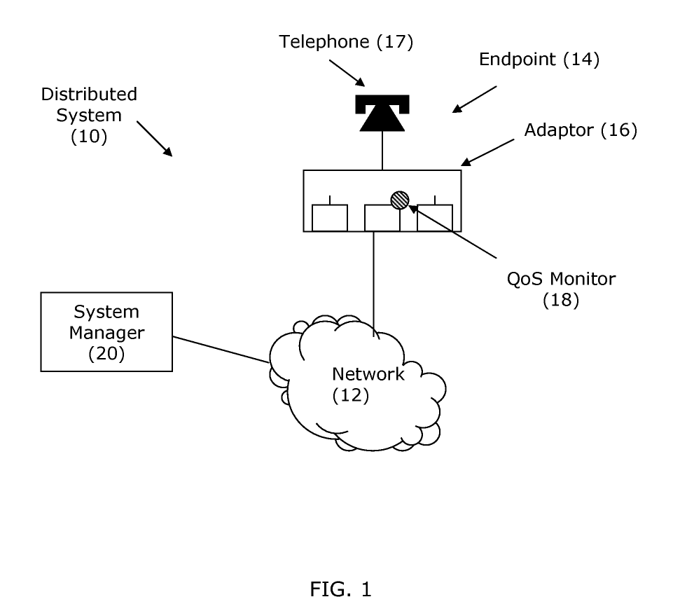

With reference to FIG. 1, a distributed system 10 in accordance with the present invention is shown for diagnosing problems in a signal at an endpoint 14 in a network 12. The distributed system 10 comprises a quality of service monitor 18 located at the endpoint 14 and a system manager 20 located generally remote from the endpoint 14. In the embodiment shown, the quality of service monitor 18 is included in an analog telephone adaptor 16, wherein the analog telephone adaptor 16 is connected to a standard telephone 17. It will be appreciated that the quality of service monitor 18 may be associated with any suitable wired or wireless device at the endpoint 14, such as an IP phone, a “softphone,” a personal digital assistant (PDA), a mobile telephone, a personal computer, a residential gateway, a cable system MTA, an IPTV set top box, or the like, and may be included in an external unit coupled to the endpoint device or as an internal component of the endpoint device.

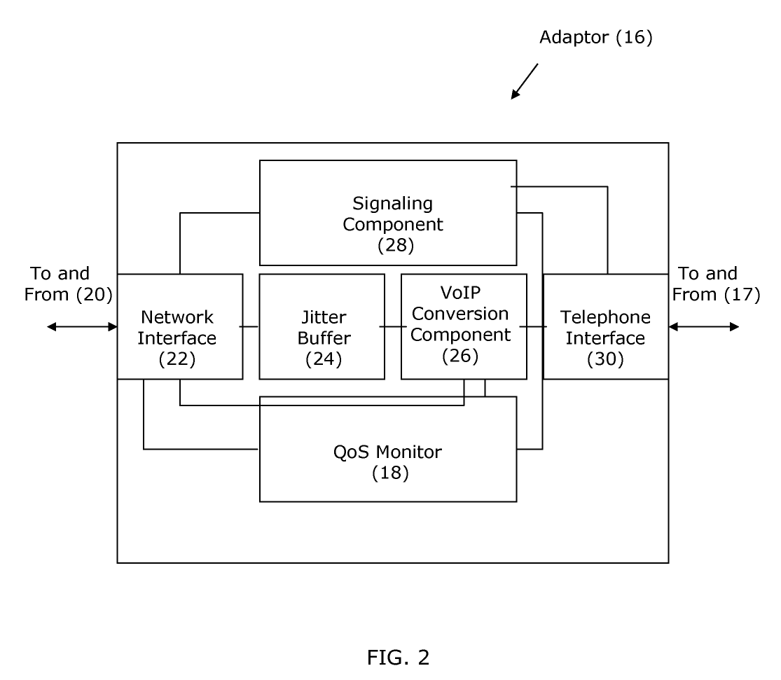

With reference to FIG. 2, the analog telephone adaptor 16 comprises a network interface 22, a jitter buffer 24, a voice over IP conversion component 26, a signaling component 28, and a telephone interface (e.g., voice ports) 30. The network interface 22 is connected to the network 12, such as by an Ethernet connection. The telephone interface 30 is connected to the telephone 17. The voice over IP conversion component 26 converts the analog voice signals received from the telephone 17 to a stream of voice over IP packets and transmits the packets over the network 12. In addition, the voice over IP conversion component 26 converts a stream of voice over IP packets received from a remote voice over IP system (not shown) to analog voice signals and transmits the analog signals to the telephone 17. The signaling component 28 establishes new calls and terminates completed calls by sending messages to the system manager 20. The signaling component 28 may also send messages that incorporate call quality (Quality of Service (QoS)), information and may direct these messages either to the system manager 20 or to a separate collection system.

The quality of service monitor 18 is incorporated into the analog telephone adaptor 16 to measure the quality of the voice over IP calls at the endpoint 14 and to generate call quality reports. Such call quality reports are sent over the network 12 to the system manager 20 using protocols such as RFC3611 (RTCP XR), SIP, or other suitable protocols as is known in the art. The quality of service monitor 18 may operate as described in U.S. Pat. No. 6,741,569, entitled “Quality of Service Monitor for Multimedia Communications System,” U.S. Pat. No. 7,058,048, entitled “Per-Call Quality of Service Monitor for Multimedia Communications System,” and/or U.S. Pat. No. 7,075,981, entitled “Dynamic Quality Of Service Monitor,” which are incorporated herein by reference.

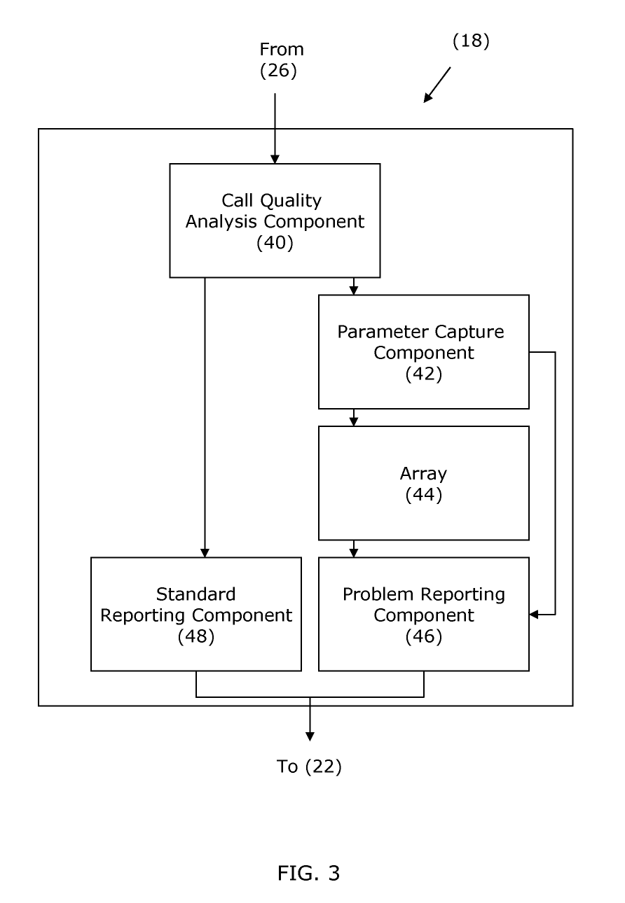

With reference to FIG. 3, the quality of service monitor 18 includes a call quality analysis component 40, a parameter capture component 42, a problem reporting component 46, and a standard reporting component 48. The call quality analysis component 40 is configured to sample values of quality parameters associated with the call signal. Such quality parameters might include measured, calculated, or estimated parameters such as estimated MOS score, R factor, delay, packet loss, jitter, signal level, noise level, echo level, distortion, absolute packet delay variation, relative packet to packet delay variation, short term delay variation, short term average delay, timing drift, and/or proportion of out-of-sequence packets.

As explained in further detail below, the quality of service monitor 18 has two modes of operation: (1) a standard mode wherein quality parameters are sampled and call quality reports are transmitted at normal intervals; and (2) a problem mode wherein quality parameters are sampled and call quality reports are transmitted at shorter intervals, i.e., at a higher frequency. The use of a higher sampling and reporting frequency is desired to obtain sufficient data for diagnosing many types of network problems. However, the use of a higher sampling and reporting frequency at all times would result in an excessive volume of call quality reports being transmitted on the network 12 and would ultimately create so much network traffic that quality would be greatly reduced. In this regard, although it is desirable to monitor the network quality at many endpoints to detect transient problems, the resulting volume of call quality report packets on the network would be equal to the number of monitored endpoints multiplied by the number of call quality report packets per second—a volume that is excessive in a network of any size. Advantageously, in accordance with the present invention, a normal sampling and reporting frequency is used while monitoring for a quality problem associated with the call signal and, if a quality problem is detected, a higher sampling and reporting frequency is used in order to gather sufficient data to diagnose the quality problem.

With continuing reference to FIG. 3, in the standard mode the call quality analysis component 40 continuously monitors the quality parameters associated with the signal and the standard reporting component 48 samples the quality parameters at normal sample intervals, such as every 5 to 20 seconds. The standard reporting component 48 incorporates the sampled values into standard call quality reports and transmits the standard call quality reports to the system manager 20 every 5 to 20 seconds and/or at the end of a call. The system manager 20 receives the standard call quality reports and stores the standard call quality reports in a database for subsequent review.

If the call quality analysis component 40 detects a quality problem, the problem mode is triggered. In the problem mode, the parameter capture component 42 samples the quality parameters associated with the signal at shortened sample intervals, such as every 200 to 500 milliseconds. The problem reporting component 46 incorporates the values sampled by the parameter capture component 42 into problem call quality reports and transmits the problem call quality reports via network interface 22 to the system manager 20. The system manager 20 receives the problem call quality reports and stores the problem call quality reports in a database for subsequent review.

In one embodiment, the call quality analysis component 40 detects a quality problem by comparing the monitored values of the quality parameters to a threshold. If the monitored values of one or more of the quality parameters exceed the threshold, a quality problem is detected and the parameter capture component 42 is signaled to begin sampling at the shortened sample intervals. The call quality analysis component 40 may also be configured to identify which one or more of the quality parameters violated the threshold. Based on the identity of such a problem quality parameter, the parameter capture component 42 may set the shortened sampling interval to a preferred interval. For example, if the problem quality parameter is identified as jitter, it may be useful to have a much finer resolution view of the data. Thus, the parameter capture component 42 could set the shortened sampling interval for jitter problems to a shorter time period than for other types of problems. The identity of the problem quality parameter may also be used by the parameter capture component 42 to select the specific quality parameter(s) for sampling at the shortened sampling interval. For example, if the problem quality parameter is identified as packet loss, it may be useful to obtain data relating to jitter to determine whether the packet loss is due to congestion. Thus, the parameter capture component 42 could select jitter as a quality parameter for sampling at the shortened sampling interval.

The problem reporting component 46 may be configured to incorporate the values sampled by the parameter capture component 42 into the problem call quality report upon termination of the call. In another embodiment, the parameter capture component 42 is configured to store the sampled values of the quality parameters in an array 44, and the problem reporting component 46 is configured to incorporate the values sampled by the parameter capture component 42 into the problem call quality report upon filling the array 44.

In one embodiment, the problem reporting component 46 incorporates the values sampled by the parameter capture component 42 into the problem call quality report by performing quantizing and compression operations on the sampled values. In particular, the problem reporting component 46 may be configured to quantize the values sampled by the parameter capture component 42, to store the quantized values in a compressed data block; and to incorporate the compressed data block into the problem call quality report.

Such quantization may include associating each of the values sampled by the parameter capture component 42 with one of a series of value ranges and quantizing the values sampled by the parameter capture component 42 based on the associated value ranges. For example, MOS-LQ values sampled by the parameter capture component 42 may be in the numerical range of 1 to 5, where a value over 4 indicates good quality. While it is useful to identify small changes in MOS when the value is higher than 3, it is less useful to identify small changes when the MOS value is low. The sampled MOS values may therefore be usefully quantized into value ranges, such as:
000=1.00-2.00
001=2.01-2.80
010=2.81-3.30
011=3.31-3.50
100=3.51-3.70
101=3.71-3.90
110=3.91-4.10
111=4.11-5.00

These value ranges may be represented in a compressed form as a “0” if a given MOS value was the same as a previous MOS value, or as a “1” followed by a three bit codeword, as listed above, if the given MOS value was different from a previous MOS value. It will be appreciated that other quantization or encoding schemes may be used, such as differential encoding, Huffman coding, Ziv-Lempel coding, or other such algorithms known to practitioners in the art.

In accordance with the present invention, it is possible to represent a period of 60 seconds sampled at a rate of 500 mS in about 123-480 bits per parameter encoded (an average size of about 200 bits per parameter). This would allow a period of 60 seconds of 4 such parameters sampled at 500 mS to be represented in a compressed data block of approximately 100 bytes.

The problem reporting component 46 incorporates the compressed data block of sampled data into a problem call quality report and transmits the problem call quality report via network interface 22 to the system manager 20 for storage. At some later point in time, the compressed data block may be retrieved and decoded to facilitate the troubleshooting of problems.

Consequently, when the call quality analysis component 40 detects a quality problem during a call, the parameter capture component 42 could immediately start to sample 4 to 8 key call quality parameters at a sampling interval of 200-500 mS for a period of 30-60 seconds, and the problem reporting component 46 could store the sampled data in a compressed data block. At the end of the call the compressed block of diagnostic data may be reported back to the system manger 20 and stored in a database. Because these steps are immediately invoked when a quality problem is detected, there is a high likelihood that the quality problem is still persisting while the data is being captured and that the samples will include information on the quality problem. Accordingly, the present invention provides the system manager 20 with a small block of compressed, sampled data on every call that experienced a problem, while keeping the overhead for obtaining this data at a minimum.

At a future time when a network administrator wishes to troubleshoot the already completed call, he can retrieve the compressed data block from the call database at the system manager 20 and graphically represent the sampled data for visual interpretation. Because the quality parameters are sampled synchronously with each other, it is possible to represent the sampled quality parameters as a series of aligned time charts.

As a result, the present invention provides a system and method wherein very large numbers of endpoints may be monitored when problems occur to obtain useful, detailed data for troubleshooting such problems. Further, in accordance with the present invention only a small additional block of data is required to be incorporated into an existing message to achieve such benefits. In addition, the solution delivered by the present invention is scaleable to millions of endpoints and greatly facilitates the process of troubleshooting transient and unpredictable problems in very large networks.

Although the invention herein has been described with reference to particular embodiments, it is to be understood that these embodiments are merely illustrative of the principals and applications of the present invention. Accordingly, while the invention has been described with reference to the structures and processes disclosed, it is not confined to the details set forth, but is intended to cover such modifications or changes as may fall within the scope of the following claims.

I claim:

1. A distributed system for diagnosing problems in a signal at an endpoint in a network, the system comprising:
a. a quality of service monitor located at the endpoint, wherein the quality of service monitor includes:
i. a call quality analysis component configured to monitor values of at least one quality parameter associated with the signal in order to detect a quality problem in the signal;
ii. a parameter capture component configured to, upon detection of the quality problem, sample values of at least one quality parameter associated with the signal at a shortened sampling interval; and
iii. a problem reporting component configured to incorporate the values sampled by the parameter capture component into a problem call quality report and to transmit the problem call quality report over the network; and
b. a system manager located in the network generally remote from the endpoint, wherein the system manager includes a database, and wherein the system manager is configured to receive the problem call quality report and to store the problem call quality report in the database.

2. The system as defined in claim 1, wherein the system manager is further configured to:
a. retrieve the problem call quality report from the database; and
b. display the values sampled by the parameter capture component to a user via an interface.

3. The system as defined in claim 1, wherein the shortened sampling interval is between about 200 milliseconds and about 500 milliseconds.

4. The system as defined in claim 1, further comprising a standard reporting component configured to:
a. sample values of at least one quality parameter associated with the signal at a normal sampling interval;
b. incorporate the sampled values into a standard call quality report; and
c. transmit the standard call quality report over the network to the system manager.

5. The system as defined in claim 4, wherein the normal sampling interval is between about 5 seconds and about 20 seconds.

6. The system as defined in claim 1, wherein the parameter capture component is configured to store the sampled values of the at least one quality parameter in an array; and wherein the problem reporting component is configured to incorporate the values sampled by the parameter capture component into the problem call quality report upon filling the array.

7. The system as defined in claim 1, wherein the problem reporting component is configured to incorporate the values sampled by the parameter capture component into the problem call quality report upon termination of a call associated with the signal.

8. The system as defined in claim 1, wherein the at least one quality parameter is selected from the group consisting of estimated MOS score, R factor, delay, packet loss, jitter, signal level, noise level, echo level, distortion, absolute packet delay variation, relative packet to packet delay variation, short term delay variation, short term average delay, timing drift, and proportion of out-of-sequence packets.

9. The system as defined in claim 1, wherein the problem reporting component is configured to quantize the values sampled by the parameter capture component; to store the quantized values in a compressed data block; and to incorporate the compressed data block into the problem call quality report.

10. The system as defined in claim 9, wherein the system manager is further configured to:
a. retrieve the problem call quality report from the database; and
b. display the quantized values to a user via an interface.

11. The system as defined in claim 9, wherein the problem reporting component is configured to:
a. associate each of the values sampled by the parameter capture component with one of a series of value ranges; and
b. quantize the values sampled by the parameter capture component based on the associated value ranges.

12. The system as defined in claim 1, wherein the call quality analysis component is configured to:
a. compare the monitored values of the at least one quality parameter to a threshold; and
b. identify a problem quality parameter if the monitored values exceed the threshold.

13. The system as defined in claim 12, wherein the parameter capture component is configured to set the shortened sampling interval based on the problem quality parameter.

14. The system as defined in claim 12, wherein the parameter capture component is configured to select the at least one quality parameter for sampling at the shortened sampling interval based on the problem quality parameter.

15. A method for diagnosing problems in a signal at an endpoint in a network, the method comprising the steps of:
a. monitoring, at the endpoint, values of at least one quality parameter associated with the signal in order to detect a quality problem in the signal;
b. upon detection of the quality problem, sampling, at the endpoint, values of at least one quality parameter associated with the signal at a shortened sampling interval;
c. incorporating the values sampled at the shortened sampling interval into a problem call quality report; and
d. transmitting the problem call quality report over the network to a system manager located generally remote from the endpoint for storage in a database.

16. The method as defined in claim 15, further comprising the steps of:
a. retrieving the problem call quality report from the database; and
b. displaying the values sampled at the shortened sampling interval to a user via an interface.

17. The method as defined in claim 15, wherein the shortened sampling interval is between about 200 milliseconds and about 500 milliseconds.

18. The method as defined in claim 15, further comprising the steps of:
a. sampling values of at least one quality parameter associated with the signal at a normal sampling interval;
b. incorporating the values sampled at the normal sampling interval into a standard call quality report; and
c. transmitting the standard call quality report over the network to the system manager.

19. The method as defined in claim 18, wherein the normal sampling interval is between about 5 seconds and about 20 seconds.

20. The method as defined in claim 15, further comprising the step of storing the values sampled at the shortened sampling interval in an array; and wherein the step of incorporating the values sampled at the shortened sampling interval into the problem call quality report is performed upon filling the array.

21. The method as defined in claim 15, wherein the step of incorporating the values sampled at the shortened sampling interval into the problem call quality report is performed upon termination of a call associated with the signal.

22. The method as defined in claim 15, wherein the at least one quality parameter is selected from the group consisting of estimated MOS score, R factor, delay, packet loss, jitter, signal level, noise level, echo level, distortion, absolute packet delay variation, relative packet to packet delay variation, short term delay variation, short term average delay, timing drift, and proportion of out-of-sequence packets.

23. The method as defined in claim 15, further comprising the steps of:
a. quantizing the values sampled at the shortened sampling interval;
b. storing the quantized values in a compressed data block; and
c. incorporating the compressed data block into the problem call quality report.

24. The method as defined in claim 23, further comprising the steps of:
a. retrieving the problem call quality report from the database; and
b. displaying the quantized values to a user via an interface.

25. The method as defined in claim 23, further comprising the step of associating each of the values sampled at the shortened sampling interval with one of a series of value ranges; and wherein the step of quantizing the values sampled at the shortened sampling interval uses the associated value ranges.

26. The method as defined in claim 15, further comprising the steps of:
a. comparing the monitored values of the at least one quality parameter to a threshold; and
b. identifying a problem quality parameter if the monitored values exceed the threshold.

27. The method as defined in claim 26, further comprising the step of setting the shortened sampling interval based on the problem quality parameter.

28. The method as defined in claim 26, further comprising the step of selecting the at least one quality parameter for sampling at the shortened sampling interval based on the problem quality parameter.
